(19) United States
(12) Patent Application Publication
(10) Pub. No.: US 2024/0335754 A1
(43) Pub. Date: Oct. 10, 2024

(54) METHOD FOR CONTROLLING VIRTUAL CHARACTER, AND ELECTRONIC DEVICE AND STORAGE MEDIUM THEREOF

(71) Applicant: NETEASE (HANGZHOU) NETWORK CO., LTD., Hangzhou, Zhejiang (CN)

(72) Inventor: Ziwei QIAN, Hangzhou, Zhejiang (CN)

(73) Assignee: NETEASE (HANGZHOU) NETWORK CO., LTD., Hangzhou, Zhejiang (CN)

(21) Appl. No.: 18/681,531

(22) PCT Filed: Mar. 16, 2022
(86) PCT No.: PCT/CN2022/081089

§ 371 Date: Feb. 6, 2024

(30) Foreign Application Priority Data
Aug. 11, 2021 (CN) 202110920136.4

(51) Int. Cl. A63F 13/56; A63F 13/214; A63F 13/58; A63F 13/822

(52) U.S. Cl. CPC A63F 13/56; A63F 13/214; A63F 13/58; A63F 13/822

(57) ABSTRACT

A method for controlling a virtual character, includes: in response to a touch operation acting on a functional control in a graphical user interface, controlling a target virtual character in a game to execute a virtual action corresponding to the functional control; and in response to a takeover control instruction for a first virtual character in the game, controlling the first virtual character to automatically follow the target virtual character, and controlling the first virtual character to automatically pick up props.

### CROSS REFERENCE TO RELATED APPLICATIONS

The present disclosure is a U.S. national phase application of International Application No. PCT/CN2022/081089, filed on Mar. 16, 2022, which is based upon and claims priority to Chinese Patent Application No. 202110920136.4, filed on Aug. 11, 2021 and entitled “METHOD FOR CONTROLLING VIRTUAL CHARACTER, AND APPARATUS AND ELECTRONIC DEVICE”, the entire contents of both of which are incorporated herein by reference for all purposes.

### TECHNICAL FIELD

The present disclosure relates to the field of computer technology, in particular to a method and an apparatus for controlling a virtual character, and an electronic device.

### BACKGROUND

In the related art, different players in a teamwork online game can interact with each other in the same game scene by operating their respective terminal devices. For example, in the FPS (First person shooter) game, different players can form a team and jointly perform game tasks in the same game scene.

### SUMMARY

According to one aspect of the present disclosure, a method for controlling a virtual character is provided, including: controlling, in response to a touch operation exerted on a functional control in a graphical user interface, a target virtual character in a game to perform a virtual action corresponding to the functional control; and controlling, in response to a takeover control instruction for a first virtual character in the game, the first virtual character to automatically follow the target virtual character and to automatically pick up a prop. According to another aspect of the present disclosure, a computer-readable storage medium is provided. The computer-readable storage medium has a computer program stored thereon, wherein the computer program is configured to implement the method for controlling a virtual character in the above when the computer program is run.

According to another aspect of the present disclosure, an electronic device is provided. The electronic device includes a memory and a processor, wherein the memory stores a computer program, and the processor is configured to run the computer program to implement the method for controlling a virtual character in the above.

### BRIEF DESCRIPTION OF THE DRAWINGS

The drawings described herein, which constitute a part of the present disclosure, are intended to provide a further understanding of the present disclosure. The illustrative embodiments and their descriptions of the present disclosure are used to explain the present disclosure and not considered to be an improper limitation of the present disclosure, in which,

FIG. 1 is a flowchart of a method for controlling a virtual character according to one or more embodiments of the present disclosure;

FIG. 2 is a schematic diagram of an method for controlling a virtual character according to one or more embodiments of the present disclosure:

FIG. 3 is a schematic diagram of an method for controlling a virtual character according to one or more embodiments of the present disclosure; and

FIG. 4 is a schematic diagram of an apparatus for controlling a virtual character according to one or more embodiments of the present disclosure.

### DETAILED DESCRIPTION

In order to enable those in the art to better understand the present disclosure, a clear and complete description of the technical solutions in embodiments of the present disclosure will be provided in the below in conjunction with the drawings. It is apparent that the embodiments described are only a part of the embodiments of the present disclosure, not all of them. Based on the embodiments of the present disclosure, any other embodiment obtained by those skilled in the art without any creative efforts will fall within the protection scope of the present disclosure.

It should be noted that terms “first”, “second”, etc. in the specification, claims, and drawings of the present disclosure are used to distinguish similar objects, and do not necessarily need to be used to describe a specific order or sequence. It should be understood that the data used in this way can be interchanged in appropriate cases, so that embodiments described can be implemented in an order other than those illustrated or described herein. In addition, terms “include” and “have”, as well as any variations thereof, are intended to cover non-exclusive inclusion. For example, the process, method, system, product, or equipment that includes a series of steps or units need not be limited to those clearly listed steps or units, but can include other steps or units that are not clearly listed or inherent to the process, method, product, or equipment.

According to one or more embodiments of the present disclosure, a method for controlling a virtual character is provided. It should be noted that steps shown in the flowchart in the drawings can be executed in a computer system by means of a set of computer executable instructions. Although a logical order is shown in the flowchart, the steps shown or described can be executed, in some cases, in an order different from the order shown.

In some embodiments of the present disclosure, the method for controlling a virtual character can run on a local terminal device or a server. When the method for controlling the virtual character runs on the server, the method can be implemented and executed based on a cloud interaction system, which includes a server and a client device.

In some embodiments of the present disclosure, various cloud applications, such as cloud games, can run on the cloud interaction system. Taking the cloud game as an example, the cloud game refers to a gaming approach based on cloud computing. In the running mode of the cloud game, a body for running a game program and a body for rendering a game screen are separated. The storage and operation of the method for controlling the virtual character are completed on the cloud game server, and the client device is used to receive and send data as well as to display the game screen. For example, the client device can be a display device having a data transmission function near a user side, for example, a mobile terminal, a TV set, a computer, a handheld computer, and the like, while the cloud game server on clouds performs the information processing. When playing the game, players operate the client devices to send operation instructions to the cloud game server. The cloud game server runs the game according to the operation instructions, encodes and compresses the game screens and other data, and returns them to the client device through the network. Finally, the client device decodes and outputs the game screen.

In some embodiments of the present disclosure, taking the game as an example, the local terminal device stores the game program and is used to display the game screen. The local terminal device is used to interact with the player through a graphical user interface, which typically involves downloading, installing, and running game programs through an electronic device. The local terminal device can provide the graphical user interface to the player in various ways, such as rendering and displaying the graphical user interface on the terminal's display screen, or providing the graphical user interface to the player through holographic projection. For example, the local terminal device can include a display and a processor. The display is configured to display the graphical user interface that includes game screens. The processor is configured to run the game, generate the graphical user interface, and control the displaying of the graphical user interface on the display.

In some embodiments of the present disclosure, a method for controlling a virtual character is provided. Based on the method, a graphical user interface is provided through a terminal device, and the terminal device herein can be the local terminal device mentioned above or the client device in the cloud interaction system mentioned above.

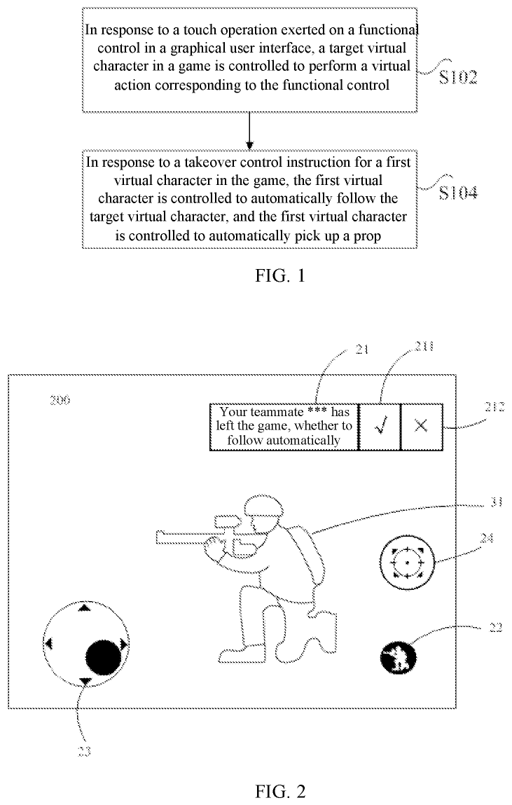

FIG. 1 is a flowchart of a method for controlling a virtual character according to embodiments of the present disclosure. As shown in FIG. 1, the method includes the steps below.

In step S102, in response to a touch operation exerted on a functional control in a graphical user interface, a target virtual character in a game is controlled to perform a virtual action corresponding to the functional control.

The above graphical user interface can be the graphical user interface on the terminal device that operates the target virtual character. The functional control can be any types of controls used in the graphical user interface to control the target virtual character. For example, the functional control can be any of a movement control, a posture control, or an aiming control. When a player performs a touch operation on the functional control in the graphical user interface, the target virtual character performs a corresponding virtual action to achieve the corresponding game effect.

For example, FIG. 2 is a schematic diagram of an optional method for controlling a virtual character according to embodiments of the present disclosure. As shown in FIG. 2, in the graphical user interface 200 of the terminal device for controlling the target virtual character, the functional controls at least include a posture control 22, a movement control 23, and an aiming control 24. Through a clicking operation on the posture control 22 by the player, the target virtual character can be made to present a posture consistent with the posture control 22. As shown in FIG. 2, the posture control 22 is a semi-kneeling posture control, and through a clicking operation on the posture control 22, the target virtual character 31 is made to perform a virtual action to present a semi-kneeling posture. The movement control 23 can be a movement rocking bar. Through a sliding operation on the rocking bar in different directions, the target virtual character 31 can be controlled to move in the corresponding direction. Through a clicking operation on the aiming control 24, the target virtual character 31 can be made to perform a virtual action to open a magnifying glass, and through a sliding operation on the aiming control 24, the target virtual character 31 can be made to adjust an aiming direction according to the direction indicated by the sliding operation.

In step S104, in response to a takeover control instruction for a first virtual character in the game, the first virtual character is controlled to automatically follow the target virtual character, and the first virtual character is controlled to automatically pick up a prop.

The above first virtual character is a virtual character being in the disconnection or the network sticking in the game scene. Based on the takeover control instruction, the first virtual character can automatically follow the target virtual character after being disconnected and pick up the prop in the game scene. After the first virtual character being disconnected is again connected to and enters the game, the automatically picked prop can be saved in a backpack, so as to prevent the virtual character from missing the dropped prop due to disconnection, thereby reducing the impact of the first virtual character's disconnection on the team's competitive power, and improving the gaming experience for players.

In some embodiments, the first virtual character and the target virtual character have a preset relationship. The above preset relationship can be determined based on a type of the game. For example, the preset relationship can be a relationship of being in the same camp, that is, the target virtual character and the first virtual character are virtual characters of the same camp. In the present disclosure, where Player A and Player B belong to the same camp means that they play together to fight against players from the other camps, or they play together to achieve a same goal in the game. For example, teammates, members of the same game alliance, etc. The above preset relationship can also be game friends, game couples, family accounts, and other relationships.

In some embodiments, controlling the first virtual character to automatically follow the target virtual character includes: controlling the first virtual character to automatically perform at least a part of the virtual action by way of following the target virtual character.

The first virtual character can perform the same virtual action as the target virtual character after following the target virtual character. The type and the quantity of virtual actions that can be automatically performed can be set according to the type of the game. The first virtual character can automatically perform only a part of virtual actions of the target virtual character, or automatically perform all virtual actions of the target virtual character. For example, the virtual actions can include moving, standing, running, squatting down, and other actions. After being followed by the first virtual character, the target virtual character needs to perform actions such as jumping over an obstacle and crawling based on the environment and the game task in the game scene. The first virtual character can perform the same actions as the target virtual character to complete the same game task. By setting the first virtual character to follow the target virtual character and to automatically perform at least a part of virtual actions, the first virtual character can be prevented from being in a stationary state when the first virtual character is disconnected, so that the first virtual character can still participate in the interaction in the game even in the disconnection or the network sticking, improving the interactive experience for players.

The above takeover control instruction can be generated by the player's touch operation on the terminal device for controlling the target virtual character, or generated by the server, based on a game state of the first virtual character in the game scene or a network state of the terminal device for controlling the first virtual character.

According to embodiments, in response to the touch operation on the functional control in the graphical user interface, the target virtual character in the game is controlled to perform the virtual action corresponding to the functional control, and in response to the takeover control instruction for the first virtual character in the game, the first virtual character is controlled to automatically follow the target virtual character, as well as controlled to automatically pick up the prop. As a result, the first virtual character can, in the case of disconnection, be able to follow its teammates and automatically picks up props, avoiding the situation where the first virtual character is unable to interact with the teammates and misses task props when it is in the disconnection or the network sticking, and reducing the impact of the disconnection of the first virtual character on teamwork, which improves the gaming experience for players, and solves the problem of the virtual character being unable to move normally or to interact with teammates in games after the disconnection, which leads to poor gaming experience in the related art.

In some embodiments, controlling the first virtual character to automatically perform at least a part of the virtual action performed by the target virtual character includes: in response to a target touch operation out of the touch operation, controlling the target virtual character in the game to perform a target virtual action corresponding to the functional control, and controlling the first virtual character to automatically perform the target virtual action performed by the target virtual character.

The target touch operation refers to a touch operation performed by the player on the terminal device that controls the target virtual character. After the target virtual character is followed by the first virtual character, the player controls the target virtual character based on the target touch operation, which can achieve indirect control of the first virtual character, so that the first virtual character performs the target virtual action.

In some embodiments, a step where in response to a target touch operation out of the touch operation, controlling the target virtual character in the game to perform a target virtual action corresponding to the functional control, and controlling the first virtual character to automatically perform the target virtual action performed by the target virtual character, includes any of below cases.

The functional control is the movement control. In response to a touch operation exerted on the movement control, the target virtual character is controlled to move along a movement direction indicated by the target touch operation, and meanwhile, the first virtual character is controlled to follow the target virtual character to move along the movement direction. As shown in FIG. 2, when the functional control is the movement control 23, the touch operation exerted on the movement control 23 can be a sliding operation, and the target touch operation can be a sliding operation exerted on the movement control 23 in any direction. For example, if the target touch operation is a sliding operation in a right direction, the target virtual character 31 is controlled to move to the right direction. The first virtual character also moves to the right direction by way of following the target virtual character 31, so that a movement direction of the first virtual character is the same as that of the target virtual character.

The functional control is the posture control. In response to a touch operation exerted on the posture control, the target virtual character is controlled to switch to a target posture indicated by the posture control, and meanwhile, the first virtual character is controlled to switch to the target posture. The target posture is a posture presented by the target virtual character in the game interface. For example, as shown in FIG. 2, when the functional control is the posture control 22, the touch operation exerted on the posture control can be a click operation. Based on the click operation on the posture control 22, the target virtual character's posture can be switched. An icon that is consistent with the target posture of the target virtual character 31 can be displayed on the posture control 22. For example, as shown in FIG. 2, the icon displayed on the posture control 22 is a semi-kneeling posture (i.e. the target posture), the target virtual character and the first virtual character are switched to the semi-kneeling posture simultaneously.

In some embodiments, the graphical user interface 200 can also include a plurality of posture controls corresponding to different postures, such as the standing posture, the crawling posture, etc. Based on click operations on different posture controls, the target virtual character and the first virtual character are controlled to switch to the corresponding posture.

The functional control is the aiming control. In response to a touch operation exerted on the aiming control, the target virtual character is controlled to adjust an aiming direction, and meanwhile, the first virtual character is controlled to adjust an aiming direction according to the same adjustment strategy. For example, as shown in FIG. 2, when the functional control is the aiming control 24, the touch operation exerted on the aiming control can include a click operation and a sliding operation. Based on the click operation exerted on the aiming control 24, the target virtual character and the first virtual character can simultaneously perform the virtual action such as opening a magnifying glass. Based on the sliding operation exerted on the aiming control 24, the target virtual character and the first virtual character can simultaneously adjust their aiming directions according to a direction indicated by the sliding operation, so that the aiming directions of the target virtual character and the first virtual character point towards the same target.

The functional control is a shooting control. In response to a touch operation exerted on the shooting control, the target virtual character is controlled to perform a shooting action, and meanwhile, the first virtual character is controlled to perform the shooting action. When the functional control is the shooting control, the touch operation exerted on the shooting control can be a click operation. Based on the click operation on the shooting control, the target virtual character and the first virtual character can perform the shooting action simultaneously.

In some embodiments, before controlling the first virtual character to automatically pick up the prop, the above method further includes: in response to a touch operation on the aiming control, the target virtual character is controlled to adjust an aiming direction. When the aiming direction is orientated towards the first virtual character, a first prop interface is displayed. The first prop interface is configured to display the props picked up by the first virtual character. In response to a selection operation on an auto-picking control in the first prop interface, the automatically picking function of the first virtual character for the prop is triggered.

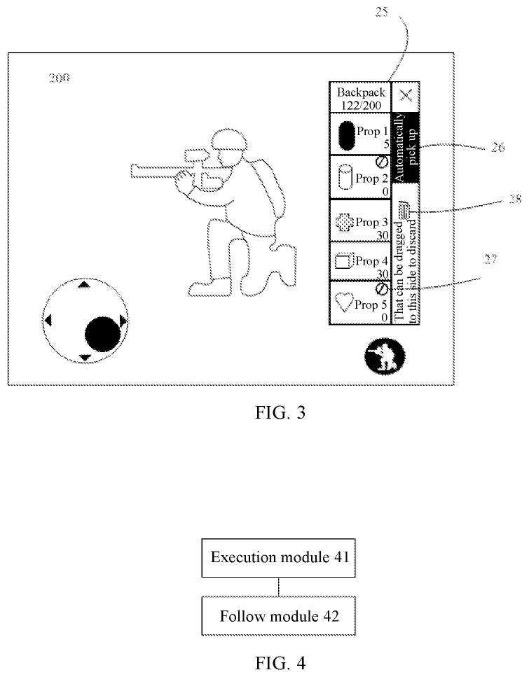

The first prop interface can display the props that the first virtual character has picked up. The touch operation on the aiming control can be a sliding operation. For example, FIG. 3 is a schematic diagram of an optional method for controlling a virtual character according to embodiments of the present disclosure. As shown in FIG. 3, in the FPS game, based on the sliding operation on the aiming control, the player can control the target virtual character to aim at the first virtual character, and the first prop interface 25 is triggered to be displayed on the graphical user interface 200 that operates the target virtual character. The first prop interface 25 can display, in the form of a backpack, the props automatically picked up by the first virtual character after the first virtual character follows the target virtual character. The first prop interface 25 is provided with an auto-picking control 26, and players can trigger an automatic picking function by performing a selection operation on the auto-picking control 26.

In some embodiments, after the first prop interface is displayed, the above method further includes: in response to a touch operation on a first target prop in the first prop interface, a picking priority of the first target prop is changed.

The first target prop is a prop displayed in the first prop interface. The player can change the picking priority of the first target prop by performing the touch operation on the first target prop. The picking priority of the first target prop mentioned above represents a picking order of multiple props when the first virtual character automatically picks up props. By changing the picking priority of the first target prop, the first virtual character can selectively pick up props that are beneficial to the teamwork, improving the gaming experience in the teamwork.

Changing the picking priority of the first target prop can include any of disabling the picking of the prop, increasing the picking priority, or decreasing the picking priority. For example, as shown in FIG. 3, the first target prop can be any of props 1-5 in the first prop interface 25. The touch operation performed on the first target prop can be a double-click operation. Based on the double-click operation on each prop in the props 1-5, the disabled prop is determined. For example, when a player double clicks on props 2 and 5, cancel icons 27 are displayed at upper right corners of the props 2 and 5, indicating that the first virtual character is not allowed to automatically pick up the props 2 and 5, and only props 1, 3, and 4 can be automatically picked up.

The touch operation performed on the first target prop can also be a sliding operation. Based on the sliding operation on the first target prop, priorities of multiple first target props are sorted. As shown in FIG. 3, based on a sliding operation up and down on any prop of the props 1-5, the priority of the prop can be sorted. For example, an order of the priority for the first virtual character to automatically pick up props is: prop 1>prop 2>prop 3>prop 4. Based on a downward sliding operation on prop 1, the picking priority of prop 1 is reduced. When prop 1 is placed between prop 2 and prop 3, it means that the order of the priority for the first virtual character to automatically pick up props is changed to: prop 2>prop 1>prop 3>prop 4. Based on an upward sliding operation on prop 4, the picking priority of prop 4 can be increased.

In some embodiments, in response to a use operation on a second target prop in the first prop interface, the first virtual character or the target virtual character is controlled to use the second target prop.

The second target prop is a prop obtained by the first virtual character based on the automatic picking function. The player who manipulates the target virtual character can use the second target prop through the use operation, so as to control using of the props automatically picked up by the first virtual character in the game, avoiding the first virtual character's inability to participate in the teamwork due to disconnection, which reduces the team's competitive power. It should be noted that the first prop interface is the prop interface for those props picked up by the first virtual character. Based on the above use operation, the second target prop can be used by the first virtual character or the target virtual character. The priority of the player using the second target prop can be determined according to preset game rules.

The using of the second target prop can be achieved through a click operation on the second target prop. For example, as shown in FIG. 3, the second target prop can be any of props 1-5 in the first prop interface 25. Based on a click operation on any of the props 1-5, the corresponding prop can be used.

In some embodiments, before controlling the first virtual character or the target virtual character to use the second target prop, the above method further includes: determining an object to which the second target prop is applied based on a type of the second target prop.

The above object to which the second target prop is applied can be virtual characters, non-player characters, etc. in the game. The type of the second target prop can be determined based on the usage and the effect function of the prop. For example, the type of the second target prop can be a recovery prop and a battle prop. For different types of props, the objects to which the props are applied can be different. For example, the recovery prop can be used to recover the health points, the vitality points, or the mana points of the virtual character, enhancing competitive power of the virtual character. Therefore, the recovery prop can be applied to virtual characters belonging to the same camp as the first virtual character. The battle prop can be used to reduce the health points of the virtual character, and the objects to which the battle prop are applied can be virtual characters belonging to different camps from the first virtual character or non-player characters.

In some embodiments, determining the object to which the second target prop is applied based on the type of the second target prop includes: in response to determining that the type of the second target prop is the recovery prop, the object to which the recovery prop is applied is determined based on a health state of a virtual character belonging to the same camp as the first virtual character; and in response to determining that the type of the second target prop is a bullet prop, the object to which the bullet prop is applied is determined based on the number of the bullet prop in the backpacks of the first virtual character and the target virtual character.

In some embodiments, in the FPS game, the recovery prop can include a medication prop, which can be used to replenish health for teammates. When there is a plurality teammates in the game, the object to which the medication prop is applied can be determined based on their health states. For example, a teammate with the lowest health points can be determined as the object to which the medication prop is applied. Based on the player's use operation on the medication prop in the first prop interface, the health points of a teammate who has lost the most health can be replenished, improving the team's survival rate.

In some embodiments, in response to determining that the type of the second target prop is the bullet prop, the object to which the bullet prop is applied is a teammate who needs to replenish the bullet resource. The first virtual character or the target virtual character with fewer bullet prop can be determined as the object to which the bullet prop is applied. Based on the player's use operation on the bullet prop, the bullet resource of the virtual character lack of the bullet resource can be replenished.

Based on the above steps, in the event that the first virtual character is in the disconnection or the network sticking and unable to participate in game interaction normally, it is possible to control the first virtual character or the target virtual character to use the prop automatically picked up after the first virtual character is disconnected, based on the player's use operation on the first prop interface, avoiding the reduction in the team's competitive power and survival rate due to first virtual character's inability to participate in the teamwork after the disconnection, thereby improving the gaming experience for players.

In some embodiments, in response to a touch operation on a third target prop and a prop discard control in the first prop interface, the first virtual character is controlled to discard the third target prop.

The third target prop can be a prop that needs to be discarded in the first prop interface. The touch operation on the third target prop and the prop discard control can be a drag operation dragging the third target prop to the prop discard control. For example, as shown in FIG. 3, the first prop interface 25 includes the prop discard control 28. The third target prop can be any of props 1-5. The prop discard control 28 is set on a side of the props 1-5. The prop discard control 28 can include a prompt message that indicates “that can be dragged to this side to discard”. When the player needs to discard a certain prop, she/he can drag the prop to the prop discard control 28, so as to achieve the operation of discarding the prop.

In some embodiments, controlling the first virtual character to automatically pick up the prop includes: a backpack usage rate of the target virtual character is obtained, which is used to indicate a proportion of the prop to the total backpack capacity, and in response to determination that the backpack usage rate is greater than a preset value, the first virtual character is controlled to automatically pick up the prop.

When automatically picking up the prop, in order to avoid resource contention between the first virtual character and the target virtual character who the first virtual character is followed, it is possible to determine based on the backpack usage rate of the target virtual character, whether to allow the first virtual character to automatically pick up the prop. The above preset value can be determined based on the preset game rules, for example, the preset value can be any reasonable value. For example, the above preset value can be 95%, indicating that the target virtual character has less space in the backpack and the first virtual character can automatically pick up the prop.

In some embodiments, when the backpack usage rate of the target virtual character is 100%, that is, when the backpack of the target virtual character is full and the target virtual character is unable to pick up the prop anymore, the first virtual character can be allowed to pick up the prop to avoid the first virtual character who is disconnected competing with the target virtual character for props. On the other hand, the props can be continued to be picked up by the first virtual character when the backpack of the target virtual character is full, so as to add more prop resources to the team and enhance the strength of team in the game, thereby improving the player's gaming experience.

In some embodiments, in response to a touch operation exerted on a backpack control in the graphical user interface, a second prop interface is displayed, which is used to display props of the target virtual character. In response to a use operation on a fourth target prop in the second prop interface, the target virtual character is controlled to use the fourth target prop.

The second prop interface displays props picked up by the target virtual character, and the fourth target prop can be any prop in the second prop interface. The use operation on the fourth target prop in the second prop interface can be a click operation on the fourth target prop. The type of the fourth target prop can be the same as that of the second target prop. For example, the fourth target prop can be the recovery prop, the bullet prop, etc.

In some embodiments of the present disclosure, the graphical user interface for manipulating the target virtual character can display both the first prop interface and the second prop interface, so that in the event of the first virtual character being in the disconnection, the player manipulating the target virtual character can use any prop in the first prop interface and the second prop interface, avoiding the reduction in the team's competitive power and survival rate due to first virtual character's inability to participate in the teamwork after the disconnection, thereby improving the gaming experience for players.

In some embodiments, before responding to the takeover control instruction for the first virtual character in the game, the above method includes: in response to a touch operation on a specified control, the takeover control instruction is generated. In some embodiments, the takeover control instruction is received, and the takeover control instruction is generated by the server based on preset rules.

The above specified control can be an auto-follow control. The takeover control instruction is generated based on the player's touch operation on the auto-follow control. The auto-follow control can be a request displayed on the graphical user interface, by way of which whether to agree to follow is inquired. The target virtual character is determined and the takeover control instruction is generated based on an agree operation from the player. For example, as shown in FIG. 2, when the first virtual character is disconnected, in the graphical user interface 200 for manipulating teammates of the first virtual character's, an auto-follow control 21 is displayed. The auto-follow control 21 can display a prompt message “Your teammate *** has left the game, whether to follow automatically”. If a teammate agrees to follow, the teammate is determined as the target virtual character for following. The target control 21 can include a confirm option 211 and a cancel option 212. The confirm option 211 is displayed as the icon “V”. By performing a selection operation on the icon “V”, the teammate itself is determined as the target virtual character, and the takeover control instruction which agrees with the first virtual character to follow the target virtual character is triggered, so that the first virtual character is controlled to follow the target virtual character and to automatically pick up props. The cancel option 212 is displayed as the icon “x”. By performing a selection operation on the icon “x”, the teammate refuses to be followed by the first virtual character, and the auto-follow control is displayed in graphical user interfaces corresponding to other teammates to determine the target virtual character.

In some embodiments, the takeover control instruction is generated by the server based on preset rules. The preset rules can be determined based on the game state of the first virtual character in the game scene or the network state of the terminal device for manipulating the first virtual character.

In some embodiments, the above preset rules can be a maximum duration during which the first virtual character remains stationary in the game scene. When the first virtual character is in a stationary state in the game scene for more than a set maximum duration, the server determines that the first virtual character is disconnected and generates the above takeover control instruction. The above preset rules can also the number of times or time the first virtual character receives interaction information sent by teammates. For example, the first virtual character still does not send any feedback information after a teammate has sent the interaction information to the first virtual character for set number of times, it is determined that the first virtual character is disconnected and the above takeover control instruction is generated. The above preset rules can also be the number of times or the duration of repeating the same action state. For example, if the first virtual character repeats the action corresponding to the player's last operation for set number of times, it is determined that the first virtual character is in the network sticking state and the above takeover control instruction is generated.

In some embodiments, the above preset rules can indicate that the network state of the terminal for manipulating the first virtual character is in faulty. The server can determine whether the network is in faulty based on the data transmission speed or data size over the network, thereby determining whether the first virtual character is in a disconnected state. The above preset rules can be a maximum duration for the first virtual character to be in a disconnected state. When the duration of the first virtual character being in the disconnection exceeds the above maximum duration, the server generates the takeover control instruction.

In some embodiments, the designated control is the auto-follow control, and generating the takeover control instruction in response to the touch operation on the specified control, includes: in response to the touch operation on the aiming control, the target virtual character is controlled to adjust an aiming direction, when the aiming direction faces towards the first virtual character, the auto-follow control is displayed, and in response to a confirmation operation on the auto-follow control, the generation of the takeover control instruction is triggered.

The touch operation on the aiming control can be a sliding operation on the aiming control, to control the target virtual character to adjust the aiming direction. For example, in FPS games, when the first virtual character is disconnected, the player can control the aiming direction to face towards the first virtual character by sliding the aiming control. At this time, the auto-follow control can be displayed on the graphical user interface for manipulating the target virtual character. The confirmation operation on the auto-follow control can be a click operation on the confirm option in the auto-follow control. Based on the above click operation, the takeover control instruction is generated.

In some embodiments, after the first virtual character participates in game interaction by way of following the target virtual character, the auto-follow control can be hidden. The player who manipulates the target virtual character can perform the touch operation on the aiming control, so as to display the auto-follow control in the graphical user interface again, and performs the cancel operation on the auto-follow control, so as to cancel the continued following by the first virtual character at any time. For example, as shown in FIG. 2, the player can control the aiming direction by sliding the aiming control, to cause the aiming direction to face towards the first virtual character. The auto-follow control 21 can be displayed on the graphical user interface for manipulating the target virtual character. The cancel operation on the auto-follow control is the click operation on the cancel option 212 (i.e. the icon “x”). When the player who manipulates the target virtual character does not want the first virtual character to continue following, the automatically following by the first virtual character can be cancelled through the click operation on the cancel option 212.

In some embodiments, the auto-follow control can be hidden after the first virtual character begins to follow the target virtual character. When the player who manipulates the target virtual character needs to change the following state of the first virtual character, the auto-follow control can be displayed again in the game interface through the touch operation on the aiming control. For example, after the target virtual character cancels the following by the first virtual character, the player who manipulates the target virtual character can trigger the displaying of the auto-follow control in the graphical user interface again through the touch operation on the aiming control, restoring the automatically following by the first virtual character.

In some embodiments, the takeover control instruction is generated by the server based on distances between a plurality of second virtual characters and the first virtual character, and the second virtual characters and the first virtual character belong to the same camp.

When there is a plurality of second virtual characters in the game scene, the server needs to select one virtual character from the plurality of second virtual characters as the target virtual character. In some embodiments, the server can obtain the distances between each second virtual character and the disconnected first virtual character in the game scene, and determine the target virtual character from the plurality of second virtual characters based on the above distances for sending the takeover control instruction.

In some embodiments, the server can determine a second virtual character closest to the first virtual character as the target virtual character and generate the takeover control instruction. The first virtual character can move across the shortest distance to follow the target virtual character. For example, the plurality of second virtual characters mentioned above are all teammates of the first virtual character. When the first virtual character is disconnected, the server obtains the distances between a plurality of teammates in the game scene and the first virtual character, determines the closest teammate to the first virtual character as the target virtual character, and generates the takeover control instruction, to control the first virtual character to automatically follow the target virtual character, and to control the first virtual character to automatically pick up props.

In some embodiments, after the second virtual character closest to the first virtual character is determined, the auto-follow control can be displayed on the graphical user interface of the second virtual character closest to the first virtual character. The player who manipulates the second virtual character can provide the feedback on whether to agree to follow through the confirm option on the auto-follow control or through the touch operation on the confirm option. When the player performs the touch operation on the confirm option, it is determined that the second virtual character closest to the first virtual character is to receive the follow request, and the second virtual character closest to the first virtual character serves as the target virtual character and generates the takeover control instruction. When the player who manipulates the closest second virtual character performs the touch operation on the cancel option, it is determined that the closest second virtual character is to reject the follow request. At this time, the server can sort the distances between a plurality of second virtual characters and the first virtual character in the game scene, in descending order, and display the auto-follow control on the graphical user interface of a second virtual character ranked second in distance (i.e. only farther than the closest virtual character), to inquire whether to agree to be followed by the first virtual character. If the second virtual character agrees to follow at this time, the second virtual character is determined as the target virtual character and generates the takeover control instruction. If the second virtual character ranked second in distance still refuses to follow, the auto-follow control will be displayed on the graphical user interface of the other second virtual characters in descending order of distance, to inquire whether to agree to be followed by the first virtual character, so as to determine the target virtual character from the plurality of second virtual characters.

In some embodiments, a method for generating the takeover control instruction by the server based on the distances between a plurality of second virtual characters and the first virtual character can further include: the server obtains the distances between a plurality of second virtual characters and the first virtual character in the game scene, and obtains additional conditions such as the terrain of the game scene where the second virtual character and the first virtual character are located, the executed game tasks, etc. Based on the above distances and additional conditions, the target virtual character is determined from the plurality of second virtual characters and the takeover control instruction is generated. For example, if the second virtual character is a teammate of the first virtual character, after the distances between each teammate and the first virtual character are obtained, it is also necessary to determine the terrain conditions between each teammate and the first virtual character. If there are terrains between the closest teammate and the first virtual character that cannot be directly traversed, such as rivers, mountains, city walls, etc., which causes the first virtual character to take a long time to follow the nearest teammate and to make a detour to reach it, then choose another teammate as the target virtual character, who is in the same terrain conditions as the first virtual character but slightly far away. In some embodiments, the teammate closest to the first virtual character may perform different subtasks than the first virtual character. If the following of the closest teammate by the first virtual character is not conducive to the execution of team tasks, the closest teammate will be selected from the teammates who perform the same subtask as the first virtual character as the target virtual character.

According to one or more embodiments of the present disclosure, an apparatus for controlling a virtual character is provided. FIG. 4 is a schematic diagram of an apparatus for controlling a virtual character according to embodiments of the present disclosure. As shown in FIG. 4, the apparatus includes an execution module 41 and a follow module 42.

The execution module 41 is configured to control, in response to a touch operation exerted on a functional control in a graphical user interface, a target virtual character in a game to perform a virtual action corresponding to the functional control. The follow module 42 is configured to control, in response to a takeover control instruction for a first virtual character in the game, the first virtual character to automatically follow the target virtual character and to automatically pick up a prop.

In some embodiments, the above follow module is further configured to control the first virtual character to automatically perform at least a part of the virtual action performed by the target virtual character.

In some embodiments, the above follow module is further configured to control, in response to a target touch operation out of the touch operation, the target virtual character in the game to perform a target virtual action corresponding to the functional control, and to control the first virtual character to automatically perform the target virtual action performed by the target virtual character.

In some embodiments, the above follow module is further configured to any of the following: wherein the functional control is a movement control, and in response to the touch operation exerted on the movement control, the target virtual character is controlled to move along a movement direction indicated by the target touch operation, while controlling the first virtual character to follow the target virtual character to move along the movement direction: or wherein the functional control is a posture control, and in response to the touch operation exerted on the posture control, the target virtual character is controlled to switch to a target posture indicated by the posture control, while controlling the first virtual character to switch to the target posture; or wherein the functional control is an aiming control, and in response to the touch operation exerted on the aiming control, the target virtual character is controlled to adjust an aiming direction, while controlling the first virtual character to adjust an aiming direction according to the same adjustment strategy: or wherein the functional control is a shooting control, and in response to the touch operation exerted on the shooting control, the target virtual character is controlled to perform a shooting action, while controlling the first virtual character to perform the shooting action.

In some embodiments, the above apparatus further includes a triggering module configured to control, in response to the touch operation on an aiming control, the target virtual character to adjust an aiming direction: display a first prop interface when the aiming direction is orientated towards the first virtual character, with the first prop interface being configured to display the prop picked up by the first virtual character; and trigger, in response to a selection operation on an auto-picking control in the first prop interface, an automatically picking function of the first virtual character for the prop.

In some embodiments, the above apparatus further includes a change module configured to change, in response to a touch operation on a first target prop in the first prop interface, a picking priority of the first target prop after displaying the first prop interface.

In some embodiments, the above apparatus further includes a prop use module configured to control, in response to a use operation on a second target prop in the first prop interface, the first virtual character or the target virtual character to use the second target prop.

In some embodiments, the above apparatus further includes an object determination module configured to determine an object to which the second target prop is applied based on a type of the second target prop before controlling the first virtual character or the target virtual character to use the second target prop.

In some embodiments, the object determination module is further configured to: determine the object to which the recovery prop is applied based on a health state of a virtual character belonging to the same camp as the first virtual character in response to determining that the type of the second target prop is a recovery prop; and determine the object to which the bullet prop is applied based on number of bullet props in backpacks of the first virtual character and the target virtual character in response to determining that the type of the second target prop is a bullet prop.

In some embodiments, the above apparatus further includes a discard module configured to control, in response to the touch operation on a third target prop and a prop discard control in the first prop interface, the first virtual character to discard the third target prop.

In some embodiments, the above follow module is further configured to: obtain a backpack usage rate of the target virtual character, with the backpack usage rate being configured to indicate a proportion of the prop to a total backpack capacity; and control, in response to determination that the backpack usage rate is greater than a preset value, the first virtual character to automatically pick up the prop.

In some embodiments, the above apparatus further includes a use module configured to display a second prop interface in response to the touch operation on a backpack control in the graphical user interface, with the second prop interface being configured to display the prop of the target virtual character; and control, in response to a use operation on a fourth target prop in the second prop interface, the target virtual character to use the fourth target prop.

In some embodiments, the above apparatus further includes an instruction generation module configured to generate the takeover control instruction in response to the touch operation on a specified control; or receive the takeover control instruction, with the takeover control instruction being generated by a server based on a preset rule.

In some embodiments, the specified control is an auto-follow control, and the instruction generation module is further configured to: control, in response to the touch operation on an aiming control, the target virtual character to adjust an aiming direction: display the auto-follow control when the aiming direction faces towards the first virtual character; and trigger generation of the takeover control instruction in response to a confirmation operation on the auto-follow control.

In some embodiments, the takeover control instruction is generated by the server based on distances between a plurality of second virtual characters and the first virtual character, and the plurality of second virtual characters and the first virtual character belong to the same camp.

In some embodiments, the first virtual character and the target virtual character have a preset relationship.

According to one or more embodiments of the present disclosure, a computer-readable storage medium is also provided. A computer program is stored in the computer-readable storage medium, and the computer program is configured to implement, when the computer program is run, the method for controlling a virtual character in any of the above embodiments.

The computer-readable storage medium is provided to store program codes for executing the following steps: controlling, in response to a touch operation exerted on a functional control in a graphical user interface, a target virtual character in a game to perform a virtual action corresponding to the functional control; and controlling, in response to a takeover control instruction for a first virtual character in the game, the first virtual character to automatically follow the target virtual character and to automatically pick up a prop.

The steps of the method for controlling a virtual character can be found in the above method embodiments, and will not be repeated here.

According to the above embodiments, the first virtual character can, in the case of disconnection, be able to follow its teammates and automatically picks up props, avoiding the situation where the first virtual character is unable to interact with the teammates and misses task props when it is in the disconnection or the network sticking, and reducing the impact of the disconnection of the first virtual character on teamwork, which improves the gaming experience for players, and solves the problem of the virtual character being unable to move normally or to interact with teammates in games after the disconnection, which leads to poor gaming experience in the related art.

According to embodiments of the present disclosure, a processor for running a program is also provided. The program is configured to implement, when the program is run, the method for controlling a virtual character in any of the above embodiments.

In some embodiments, the above processor can be configured to execute the following steps through the program: controlling, in response to a touch operation exerted on a functional control in a graphical user interface, a target virtual character in a game to perform a virtual action corresponding to the functional control; and controlling, in response to a takeover control instruction for a first virtual character in the game, the first virtual character to automatically follow the target virtual character and to automatically pick up a prop.

The steps of the method for controlling a virtual character can be found in the above method embodiments, and will not be repeated here.

According to the above embodiments, the first virtual character can, in the case of disconnection, be able to follow its teammates and automatically picks up props, avoiding the situation where the first virtual character is unable to interact with the teammates and misses task props when it is in the disconnection or the network sticking, and reducing the impact of the disconnection of the first virtual character on teamwork, which improves the gaming experience for players, and solves the problem of the virtual character being unable to move normally or to interact with teammates in games after the disconnection, which leads to poor gaming experience in the related art.

According to embodiments of the present disclosure, an electronic device is also provided. The electronic device includes a memory and a processor. The memory stores a computer program, and the processor is configured to run the computer program and to control, in response to a touch operation exerted on a functional control in a graphical user interface, a target virtual character in a game to perform a virtual action corresponding to the functional control; and control, in response to a takeover control instruction for a first virtual character in the game, the first virtual character to automatically follow the target virtual character and to automatically pick up a prop.

The steps of the method for controlling a virtual character can be found in the above method embodiments, and will not be repeated here.

According to the above embodiments, the first virtual character can, in the case of disconnection, be able to follow its teammates and automatically picks up props, avoiding the situation where the first virtual character is unable to interact with the teammates and misses task props when it is in the disconnection or the network sticking, and reducing the impact of the disconnection of the first virtual character on teamwork, which improves the gaming experience for players, and solves the problem of the virtual character being unable to move normally or to interact with teammates in games after the disconnection, which leads to poor gaming experience in the related art.

The above embodiments of the present disclosure are only for description and do not represent advantages or disadvantages of the embodiments.

In the above embodiments of the present disclosure, each embodiment has its own emphasis on description. For those parts not detailed in one embodiment, reference can be made to the relevant description of other embodiments.

According to embodiments provided in the present disclosure, it should be understood that the technical contents disclosed can be implemented in other manners. For example, the apparatus embodiments described above are only illustrative. For example, division of units is only a logical function division. In a practice implementation, there can be other divisions. For example, multiple units or components can be combined or can be integrated into another system, or some features can be ignored, or not implemented. In addition, mutual coupling or direct coupling or communication connection shown or discussed can be indirect coupling or communication connection through some interfaces, devices or units, and can be in electrical or other forms.

The units described as separate components may or may not be physically separated, and components displayed as units may or may not be physical units. That is, the components displayed as units can be located in one place, or can be distributed to multiple network units. Some or all of the units can be selected according to actual needs to implement solutions provided in embodiments of the present disclosure.

In addition, functional units provided in embodiments of the present disclosure can be integrated into one processing unit, or the functional units can exist physically alone, or two or more functional units can be integrated into one unit. The above-mentioned integrated units can be implemented not only in the form of hardware, but also in the form of software functional modules.

If the integrated units are implemented in the form of software functional modules and sold or used as an independent product, they can be stored in a computer-readable storage medium. Based on such understanding, technical solutions of the present disclosure can essentially or in part, contribute to the prior art, or all or part of the technical solutions can be embodied in the form of a software product, which is stored in a storage medium and includes several instructions to cause a computer device (which may be a personal computer, a server, or a network device, etc.) to implement all or part of the steps of the methods described in various embodiments of the present disclosure. The aforementioned storage medium includes various media that can store program codes, such as U disk, read-only memory (ROM), random access memory (RAM), portable hard drive, magnetic disk or optical disk, etc.

The above is only some embodiments of the present disclosure. It should be noted that for those of ordinary skill in the art, several modifications and improvements can be made without departing from the principle of the present disclosure. The modifications and improvements should also be considered to be within the protection scope of the present disclosure.

1. A method for controlling a virtual character, comprising:
controlling, in response to a touch operation exerted on a functional control in a graphical user interface, a target virtual character in a game to perform a virtual action corresponding to the functional control; and
controlling, in response to a takeover control instruction for a first virtual character in the game, the first virtual character to automatically follow the target virtual character and to automatically pick up a prop.

2. The method according to claim 1, wherein controlling the first virtual character to automatically follow the target virtual character comprises:
controlling the first virtual character to automatically perform at least a part of the virtual action performed by the target virtual character.

3. The method according to claim 2, wherein controlling the first virtual character to automatically perform at least a part of the virtual action performed by the target virtual character comprises:
controlling, in response to a target touch operation out of the touch operation, the target virtual character in the game to perform a target virtual action corresponding to the functional control, and controlling the first virtual character to automatically perform the target virtual action performed by the target virtual character.

4. The method according to claim 3, wherein controlling the first virtual character to automatically perform the target virtual action performed by the target virtual character, comprises any one of:
wherein the functional control is a movement control, and in response to the touch operation exerted on the movement control, the target virtual character is controlled to move along a movement direction indicated by the target touch operation, while controlling the first virtual character to follow the target virtual character to move along the movement direction;
wherein the functional control is a posture control, and in response to the touch operation exerted on the posture control, the target virtual character is controlled to switch to a target posture indicated by the posture control, while controlling the first virtual character to switch to the target posture;
wherein the functional control is an aiming control, and in response to the touch operation exerted on the aiming control, the target virtual character is controlled to adjust an aiming direction, while controlling the first virtual character to adjust an aiming direction according to the same adjustment strategy: or
wherein the functional control is a shooting control, and in response to the touch operation exerted on the shooting control, the target virtual character is controlled to perform a shooting action, while controlling the first virtual character to perform the shooting action.

5. The method according to claim 1, further comprising:
controlling, in response to the touch operation on an aiming control, the target virtual character to adjust an aiming direction;
displaying a first prop interface when the aiming direction is orientated towards the first virtual character, wherein the first prop interface is configured to display the prop picked up by the first virtual character; and
triggering, in response to a selection operation on an auto-picking control in the first prop interface, an automatically picking function of the first virtual character for the prop.

6. The method according to claim 5, further comprising:
changing, in response to a touch operation on a first target prop in the first prop interface, a picking priority of the first target prop.

7. The method according to claim 5, further comprising:
controlling, in response to a use operation on a second target prop in the first prop interface, the first virtual character or the target virtual character to use the second target prop.

8. The method according to claim 7, further comprising:
determining an object to which the second target prop is applied based on a type of the second target prop.

9. The method according to claim 8, wherein determining the object to which the second target prop is applied based on the type of the second target prop comprises:
in response to determining that the type of the second target prop is a recovery prop, determining the object to which the recovery prop is applied based on a health state of a virtual character belonging to the same camp as the first virtual character; and
in response to determining that the type of the second target prop is a bullet prop, determining the object to which the bullet prop is applied based on number of bullet props in backpacks of the first virtual character and the target virtual character.

10. The method according to claim 5, further comprising:
controlling, in response to the touch operation on a third target prop and a prop discard control in the first prop interface, the first virtual character to discard the third target prop.

11. The method according to claim 1, wherein controlling the first virtual character to automatically pick up the prop comprises:
obtaining a backpack usage rate of the target virtual character, wherein the backpack usage rate is configured to indicate a proportion of the prop to a total backpack capacity; and
controlling, in response to determination that the backpack usage rate is greater than a preset value, the first virtual character to automatically pick up the prop.

12. The method according to claim 1, further comprising:
displaying a second prop interface in response to the touch operation on a backpack control in the graphical user interface, wherein the second prop interface is configured to display the prop of the target virtual character; and
controlling, in response to a use operation on a fourth target prop in the second prop interface, the target virtual character to use the fourth target prop.

13. The method according to claim 1, further comprising:
generating the takeover control instruction in response to the touch operation on a specified control; or
receiving the takeover control instruction, wherein the takeover control instruction is generated by a server based on a preset rule.

14. The method according to claim 13, wherein the specified control is an auto-follow control, and generating the takeover control instruction in response to the touch operation on the specified control comprises:
controlling, in response to the touch operation on an aiming control, the target virtual character to adjust an aiming direction;
displaying the auto-follow control when the aiming direction faces towards the first virtual character; and
triggering generation of the takeover control instruction in response to a confirmation operation on the auto-follow control.

15. The method according to claim 13, wherein the takeover control instruction is generated by the server based on distances between a plurality of second virtual characters and the first virtual character, and wherein the plurality of second virtual characters and the first virtual character belong to the same camp.

16. The method according to claim 1, wherein the first virtual character and the target virtual character have a preset relationship.

17. (canceled)

18. A non-transitory computer-readable storage medium having a computer program stored thereon, wherein the computer program is configured to implement the method for controlling a virtual character according to claim 1 when the computer program is run.

19. (canceled)

20. An electronic device comprising a memory and a processor, wherein the memory stores a computer program, and the processor is configured to:
control, in response to a touch operation exerted on a functional control in a graphical user interface, a target virtual character in a game to perform a virtual action corresponding to the functional control; and
control, in response to a takeover control instruction for a first virtual character in the game, the first virtual character to automatically follow the target virtual character and to automatically pick up a prop.

21. The method according to claim 13, wherein the preset rule can be determined based on a game state of the first virtual character or a network state of a terminal device for manipulating the first virtual character.

22. The method according to claim 21, wherein the preset rule comprises at least one of:
a maximum duration during which the first virtual character remains stationary in the game;
number of times or time the first virtual character receives interaction information sent by a teammate;
number of times or a duration the first virtual character repeats the same action; or
a maximum duration during which the terminal device for manipulating the first virtual character encounters network faulty.
